(19) United States
(12) Patent Application Publication
(10) Pub. No.: US 2006/0072919 A1
(43) Pub. Date: Apr. 6, 2006

(54) Infra red networking system and method

(76) Inventor: Guy Edelist, Tel-Aviv (IL)

Correspondence Address: DANIEL J SWIRSKY, 55 REUVEN ST., BEIT SHEMESH, 99544, IL

(21) Appl. No.: 10/537,090

(22) PCT Filed: Nov. 28, 2003
(86) PCT No.: PCT/IL03/01014

§ 371 Date: Jun. 2, 2005

(30) Foreign Application Priority Data
Nov. 29, 2002 (IL) 153188

(51) Int. Cl. H04B 10/00

(52) U.S. Cl. 398/135

(57) ABSTRACT

A system and device for wireless communication and networking featuring a chipset with Infrared transmitting and receiving capabilities especially for in airplanes including and integrated infrared chip (INchip), a driver, a user device, a communication box and an infrared transceiver.

### FIELD AND BACKGROUND OF THE INVENTION

The present invention relates to a device and system for communication and networking featuring a chipset with Infrared transmitting and receiving capabilities. Furthermore, the present invention is of a method of using a device and system featuring a chipset with IR transmitting and receiving capabilities. In particular, it concerns a device, system and method for local wireless networking for use in airplanes.

Mobile communication devices include, but are not limited to mobile phones, cellular phones laptop computers, pocket PC and Palm size PC. The mobile communication devices known in the art as well as stationary devices, such as PC, servers and telecommunication equipment use RF waves to deliver voice and data, between the communication device and the base station or cellular antenna.

Conventional airplanes use wires to provide networking services, such as voice communication, controlling and sending indicator signals, video transferring, onboard communication, entertainment, transponder signals and the like. The cables are optionally regular cables or fiber optic or any suitable capable, which stands up to the required specifications. Originally, steel cables were used in order to provide a robust system. However, eventually the steel cables were replaced with hydraulic lines with no mechanical connection. Today, airplanes utilize a fly by wire system, whereby only a thin wire connects the pilot's controls to the wings. Conventional wireless systems commonly use ranges of RF, which cause interference with sensitive airplane systems. As such, use of RF based devices are not allowed during the flight.

Some modern airplanes are equipped with on seat telephone devices, which allow passengers to make outgoing calls. A disadvantage of this system is that the user has no dedicated number. Even if the user had a number, he would have to inform all potential callers before the flight of the number. Personal mobile phones are not available for use on a flight due to possible interference from RF and electromagnetic waves and because most of the flight time the airplane is not covered by cellular services. Therefore, passengers are not fully using the onboard telephone system.

A latent deficiency of the use of communication devices, which employ RF waves is as detailed above that in places with (EMI) Electro Magnetic Interference, there is interference with the communication. There is no such interference between electro magnetic waves and infrared.

Currently, there is no mobile or stationary communication device or systems which features a chipset with IR transmitting and/or receiving capabilities, thereby allowing roaming on airplanes.

There is therefore a need for a communication device and system, which features a chipset with IR transmitting and/or receiving capabilities, such as disclosed in the present invention. Such a communication device and system and method of using such a system provides a solution to the aforementioned problems.

### SUMMARY OF THE INVENTION

The present invention relates to a device and system for communication and networking featuring a chipset with Infrared transmitting and receiving capabilities. Moreover, the present invention is of a method of using a device and system featuring a chipset with IR transmitting and receiving capabilities. Preferably, the present invention is of a device, system and method for local wireless networking for use in airplanes.

In a first embodiment the present invention provides a communication device using infrared including; (a) Integrated infrared chip (INChip); (b) a driver and (c) an infrared transceiver.

In a preferred embodiment the INChip supports infrared wireless networking.

In a preferred embodiment the device is for use on an aircraft.

In a preferred embodiment the infrared transceiver is an antenna, for readily negotiating between an end device connected to the infrared chip and a network section

In a preferred embodiment the device is selected from at least one of the group consisting of mobile phones, mobile headsets, mobile two way headsets, dedicated Computer cards, a digital camera, PDA, laptops and a combination thereof.

In a preferred embodiment the INChip has infrared transmitting/receiving capabilities.

In a preferred embodiment the INChip transmits all the necessary information to the device it is attached to.

In a preferred embodiment the INChip is integrated inside the communication device.

In a preferred embodiment the INChip is located outside the communication device.

In a preferred embodiment the communication device is connected to an external device for infrared transceiving.

In a preferred embodiment the external device for infrared transceiving includes an INChip and an infrared transceiver.

In a preferred embodiment the device is connected by a connection device to the external device for infrared transceiving.

In a preferred embodiment the INChip includes modular based software.

In a preferred embodiment the software is configured to support a plurality of communication devices.

In a preferred embodiment the software is configured to have a plurality of variations for readily facilitating firmware changing.

In a preferred embodiment the INChip is configured to readily facilitate application with a variety of different devices, servers, applications and manufacturers.

In a preferred embodiment the device identifies voice and data infrared networking.

In a preferred embodiment the driver readily facilitates attaching the device to a wireless networking system (INetworking).

In a preferred embodiment the one end of the driver connects to an end device and the other end of the driver connects to compatible protocol for INetworking.

In a preferred embodiment the device is configured to readily facilitate switching between RF to IR networking.

In a preferred embodiment the switching between RF and IR is done manually.

In a preferred embodiment the device can be integrated into any kind of existing infrared network system.

In a second embodiment the present invention provides a wireless networking system (INetworking) including: (a) a computer based server (INServer); (b) communication boxes (COMbox); (c) access points (AP); (d) at least one user device (UD); and (e) an Integrated infrared chip (INChip).

In a preferred embodiment the system serves multi users simultaneously.

In a preferred embodiment the system supports all data and information packages inside an airplane.

In a preferred embodiment the system provides roaming, readily facilitating continuous connection when users go from one antenna coverage to another

In a preferred embodiment the system is configured to readily facilitate sending and receiving information and data from and to a plurality of sources.

In a preferred embodiment the sources are selected from the group consisting of cellular phone from microcell or a base station connection, voice over IP, voice by using internal intercom or telephonic systems.

In a preferred embodiment the UD is a stand alone UD

In a preferred embodiment the user device is any mobile or stationary communication device with incorporated INChip.

In a preferred embodiment the UD includes the INChip.

In a preferred embodiment the user device is selected from one or a combination of UD phone, UD adaptor, UD card, UD terminal, UD headset, camera and UD card, laptop and UD card and PDA and UD card.

In a preferred embodiment the UD is connected to the AP using diffused infrared technology.

In a preferred embodiment the AP is wired between the UD and the INServer.

In a preferred embodiment the system is for use on an airplane.

In a preferred embodiment the INServer controls voice calls, data and video services in the airplane.

In a preferred embodiment the INServer receives information from different sources in the airplane and from sources of other providers.

In a preferred embodiment the providers are selected from one or a combination from the group of ground telephony services via satellite connection, internet and email services.

In a preferred embodiment the user device is a UD phone configured to readily facilitate making outgoing call, receiving calls, sending SMS messages using WAP services and internet connection.

In a preferred embodiment the UD phone includes an SIM card reader to read SIM card identity.

In a preferred embodiment the user device is a UD terminal configured to readily facilitate the airplane crew in the cockpit to be in constant communication with the airplane staff.

In a preferred embodiment the user device is a headset configured to readily facilitate providing a means for passenger's entertainment, service and crew communication.

In a preferred embodiment the headset include a coder/encoder facilitating voice transmitting security.

In a preferred embodiment the system is configured to deliver video images from a camera in the airplane.

In a preferred embodiment the system is configured to deliver data from sensors and gauges in the airplane to the cockpit.

In a preferred embodiment the system is for use in any form of transportation where mobility is needed.

In a preferred embodiment the transportation is selected from the group consisting of aircraft, submarines, trains and ships.

In a preferred embodiment the access point is a fixed transceiver unit, configured to readily facilitate connection between UD via infrared beams and Communication boxes.

In a preferred embodiment the communication boxes include HUB, switch and router by fixed lines or cables.

In a preferred embodiment the one side of the communication box is connected to the AP and a second side of the communication boxes is connected to the INServer.

In a preferred embodiment the access points provide two-way communication of video, voice and data to and from the user devices.

In a preferred embodiment there are a plurality of communication boxes, wherein each communication box has a different function.

In a preferred embodiment there is one communication box configured to readily facilitate all applications.

In a preferred embodiment the INServer is a computer with processing and storage facilities.

In a preferred embodiment the INServer includes a package of hardware and software together.

In a preferred embodiment the INServer includes a modular software based application for readily installing in a computer.

In a preferred embodiment the computer software controls the wireless communication system.

In a preferred embodiment the INServer includes a flight information back up system, cabin door control and black box reader.

In a preferred embodiment the INServer includes a built in cellular engine/modem connected by a cellular network to the user, when the airplane is on the ground.

In a preferred embodiment during flight the INServer is connected to third party providers of ground connection, which use satellite to deliver information.

In a third embodiment the present invention provides a wireless networking system (INetworking) for use in an aircraft including: (a) a computer based server (INServer); (b) communication boxes (COMbox); (c) access points (AP); (d) at least one user device (UD); and (e) an Integrated infrared chip (INChip).

In a fourth embodiment the present invention provides a method of using a communication device including the following steps: (a) providing a communication device including; (i) Integrated infrared chip (INChip); (ii) a driver; and (iii) an infrared transceiver; and (b) receiving and transmitting messages with the communication device.

In a fifth embodiment the present invention provides a method of using a wireless networking system in an aircraft including the steps of: (a) providing a wireless networking system including: (i) a computer based server (INServer); (ii) communication boxes (COMbox); (iii) access points (AP); (v) at least one user device (UD); and (vi) an Integrated infrared chip (INChip); (b) connecting the UD to the AP, wherein the AP is configured to readily facilitate connection between the UD and the Communication boxes; (c) connecting the AP to the communication boxes; (d) connecting a second side of the communication boxes to the INServer (e) connecting the INServer to a ground telephony server; and (f) connecting the ground telephony server to ground services; and (b) receiving and transmitting messages with the UD.

The term ‘communication’ as used herein includes, but is not limited to, networking of wires and wireless components.

The term ‘wireless’ as used herein includes, but is not limited to, two way wireless communication wherein connection does not need wires and can be directional from point to point or spread using access points.

The term ‘airplane’ as used herein includes, but is not limited to any size or type of airplane, such as a small business jet, a commercial plane and a military plane.

The term ‘computer communication’ as used herein includes, but is not limited to, any suitable type of flow of any suitable type of computer data from any computer system to another computer system.

The term ‘telephone’ as used herein includes, but is not limited to any instrument configured to dial a telephone number and connect with a dialed number, such as, but not limited to a telephone, phone, cellular phone or mirs device. The term also includes an electrical device fro transmitting speech, consisting of a microphone and receiver mounted on a handset. The term also includes a worldwide system of communications using telephones. The microphone in one telephone converts sound waves into electrical signals that are transmitted along a telephone wire or by radio to one or more distant sets.

The term ‘communication device’ as used herein includes, but is not limited to a device for receiving and/or transmitting information, such as voice, telephonic services, intercom, two way messaging, SMS, data, images, video, Email and internet, to or from a second party. The term includes mobile and stationary communication devices. Mobile communication devices include, but are not limited to mobile phones, cellular phones, Wireless telephone cameras, laptop computers, pocket PC and Palm size PC. Stationary devices, include PC, servers and telecommunication equipment.

The term ‘driver’ as used herein includes, but is not limited to, a program that controls the operation of a device.

The term ‘infrared transceiver’ as used herein includes a device, which transmits and receives signals, such as an infrared antenna and which negotiates between the end device connected to the chipset and the network section.

The term ‘infrared wireless networking’ as used herein includes, but is not limited to communication, such as voice, telephonic services, intercom, two way messaging, SMS, data, images, video, Email and internet between a user and at least one second source using infrared radiation to transmit and receive information.

The term ‘infrared’ as used herein includes, but is not limited to a region of the electromagnetic spectrum where the frequency is below the red end of the visible spectrum

### BRIEF DESCRIPTION OF THE DRAWINGS

The invention is herein described, by way, of example only, with reference to the accompanying drawings, wherein:

FIG. 1 shows a schematic view of one embodiment of the device of the present invention, wherein a chipset with IR transmitting/receiving capabilities is integrated in a mobile device;

FIG. 2 shows a schematic view of an alternative embodiment of the device of the present invention, wherein a chipset with IR transmitting/receiving capabilities is added as an outside apparatus; and

FIG. 3 shows a schematic view of the system of the present invention as part of an airplane system.

### DESCRIPTION OF THE PREFERRED EMBODIMENTS

The present invention is a communication and networking system featuring a chipset with Infrared transmitting and receiving capabilities. Moreover, the present invention is of a method of using a system featuring a chipset with IR transmitting and receiving capabilities. Preferably, the present invention is of a device, system and method for local wireless networking for use in airplanes in flight and on the ground. More specifically, the present invention is a wireless device and system configured to deliver voice, telephonic services, intercom, two way messaging, SMS, data, images, video, Email and internet content inside an airplane using infrared diffused networking, which is in the safe range for use inside airplanes.

The present invention provides a means of mobile communication for airplane crew by handheld or headset terminals. In addition, the present invention provides onboard wireless network for data, video and delivery of flight information to the cockpit from different sensors. The system of the present invention is configured to reduce weight, wiring and complexity of existing wired systems.

The wireless networking (INetworking) system of the present invention works at a level, which does not disturb avionic systems. In addition, the system of the present invention is not influenced by electronic noise, such as electromagnetic interference from airplane systems and components.

The device of the present invention includes an Integrated infrared chip (chipset—INChip) and a driver. Preferably, a user of the INetworking system of the present invention employs a device with a chip, such as an Integrated infrared chip (INChip), which supports the INetworking by means of behaviour as a network protocol and layout part. Devices which feature a chip include, but are not limited to, mobile phones, wireless telephone, mobile headsets, mobile two way headsets, dedicated Computer cards, such as PCMCIA or USB external devices, or any expansion slot, a digital camera, PDA and laptops. Optionally, the INChip can be embedded inside a Laptop or PDA as software or firmware.

The device of the present invention features a chipset with IR transmitting/receiving capabilities. In one preferred embodiment the chipset can be integrated inside a chipset, which is implemented in the communication device. In an alternative preferred embodiment, the chipset is located outside or is a supplement to the communication device. Preferably, the chipset controls the receiving information and delivers all the necessary information from the Infrared eye to the apparatus it is attached to.

Preferably, the core software inside the INChip is modular based in order to support a plurality of different devices. The software is configured to have many variations for firmware changing. Firmware changing is preferably, done online using wire/wireless devices with external computer or computer sources, which transmits the required data to upgrade the firmware.

The INChip of the present invention is configured to readily facilitate application with a variety of different devices, servers, applications and manufacturers.

The INChip of the present invention can function as an adaptor with hardware parameters to fit appliances it is implemented in. This is preferably, achieved by a set of drivers to fit the appliances from one side and compatible protocol of the INetworking from the other side.

Preferably, the device of the present invention includes an infrared antenna. An infrared antenna is a transceiver, which negotiates between the end device connected to the chipset and the network section.

Preferably, the device of the present invention identifies voice/Data IR networking, and is configured to readily facilitate automatic and/or seamless switching between the RF to IR networking. Optionally, the switching between RF to IR is done manually, whereby the device is configured to provide the available options to the user.

Preferably, the device of the present invention identifies voice/Data RF networking, and is configured to readily facilitate automatic and/or seamless switching between the IR to RF networking. Optionally, the switching between IR to RF is done manually, whereby the device is configured to provide the available options to the user.

Preferably, the infrared transferring does not require using a standard Ethernet protocols known in the art. Information is transferred by infrared in the same infrastructure of sockets, wires, junctions, hubs, switches, servers and the like. Namely, the IR transferring utilizes a distinctive protocol for connecting between network components. The network of the present invention can define and serve multi users in the same time with the relevant identity and billing information for each one of them.

The network of the present invention also provides roaming, whereby users can go from one antenna coverage area to another and the connection is always available. The network of the present invention is configured to readily facilitate sending and receiving various information and data from and to a plurality of sources, such as, but not limited to, cellular phone from microcell or a base station connection, voice over LP, data, voice by using internal intercom or telephonic systems and using parts of existing infrastructures.

The device of the present invention can be integrated into every kind of existing network system, which uses or can use infrared.

Preferably, the system of the present invention features a computer based server (INServer), communication boxes (COMbox), access points (AP), user devices (UD) and a core technology electronic chip (INChip). Preferably, INetworking supports all data and information packages including data from transponders inside the airplane, remote controllers for security and cabin door lock mechanism.

The hardware apparatus of the present invention optionally works as a stand alone user device (UD), or alternatively is incorporated into any mobile or stationary communication device. Examples of UD technology devices include, but are not limited to UD phone, UD adaptor, UD card, UD terminal and UD headset. Preferably, the UD features the INChip inside.

Preferably, the UDs have an INChip technology embedded inside. Preferably, the UDs connect to the AP using diffused infrared technology, wherein the APs are wired between the UD and the INServer. Preferably, the INServer manages the voice calls, SMS messaging, data and video service inside the airplane. Preferably, the INServer gathers information from different sources inside the airplane and is connected to other sources of other providers, such as, but not limited to ground telephony services via satellite connection, internet and email services and the like.

In addition, the INetworking is optionally configured to deliver video images from video cameras or any digital camera in the airplane. The INetworking is also capable of delivering data from sensors and gauges to the cockpit. The INetworking readily facilitates a plurality of users simultaneously using the system. Preferably, the INetworking allocates the resources to make the connection between the INChips and the INServer. All calls are transferred through the COMbox, but the main control is inside the INServer.

The communication system of the present invention is geared towards a multiplicity of different users including, but not limited to airlines, banks, military institutions transportation industry, commercial data security institutions, secured organizations and the like. It is envisaged that the system of the present invention will find use in airplanes submarines, trains or in any other form of transportation where mobility is needed and conventional wireless systems cannot be used.

Preferably, the system and method of the present invention will be especially useful and/or efficient in places and location wherein conventional Radio based wireless systems are inoperable and/or the use thereof is barred, forbidden, limited, substantially impaired or depleted.

The principles and operation of a communication system, according to the present invention may be better understood with reference to the drawings and the accompanying description. The figures are not limiting.

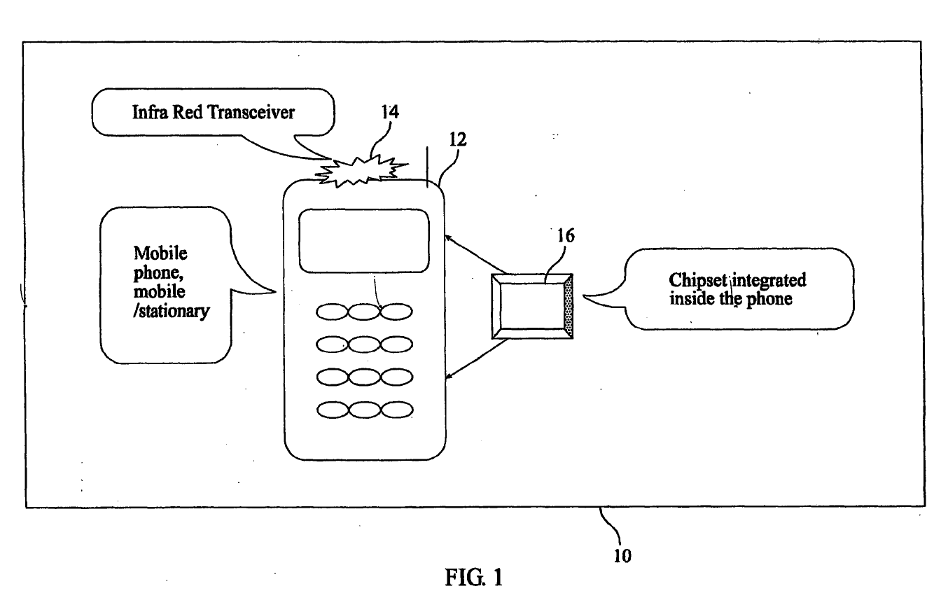

FIG. 1 shows a schematic view of one embodiment of the device of the present invention, wherein a chipset with IR transmitting/receiving capabilities is integrated in a communication device 10. As can be see in FIG. 1, a communication device 12, such as a phone device 12 features an infrared transceiver 14 and an Integrated infrared chip (chipset) 16.

Communication device 12 is any type of suitable communication device, such as, but not limited to mobile phones, mobile headsets, mobile two way headsets, dedicated Computer cards, such as PCMCIA or USB external devices, or any expansion slot, a digital camera, PDA and laptops. FIG. 1 shows a phone device 12. Phone device 12 is optionally any size and type of suitable phone device, such as, but not limited to, a mobile phone, a cellular phone and a stationary device.

Preferably, chipset (INChip) 16 is integrated inside phone device 12. Preferably, chipset 16 controls the receiving information and delivers all the necessary information from the Infrared eye to the apparatus it is attached to. Preferably, the core software inside INChip 16 is modular based in order to support a plurality of different communication devices 12. Preferably, INChip 16 is configured to readily facilitate application with a variety of different devices, serves, applications and manufacturers. INChip 16 preferably uses, specific drivers to attach a device to INetworking.

Preferably, Infrared transceiver 14 is an antenna, which readily negotiates between an end device 12 connected to chipset 16 and a network section.

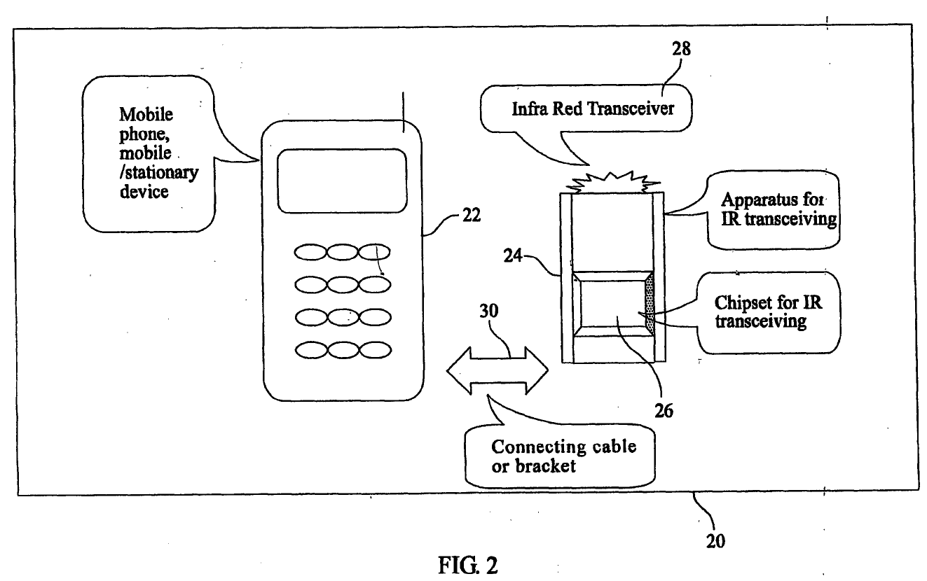

FIG. 2 shows a schematic view of an alternative embodiment of the device of the present invention, wherein a chipset with IR transmitting/receiving capabilities is added as an outside apparatus 20. As can be see in FIG. 2, a phone device 22 is connected to a device for Infrared transceiving 24.

Device for infrared transceiving 24 includes a chipset for IR transceiving 26 and an infrared transceiver 28. Optionally, phone device 22 is connected to device for infrared transceiving by any suitable connection device 30, such as but not limited to a cable or bracket.

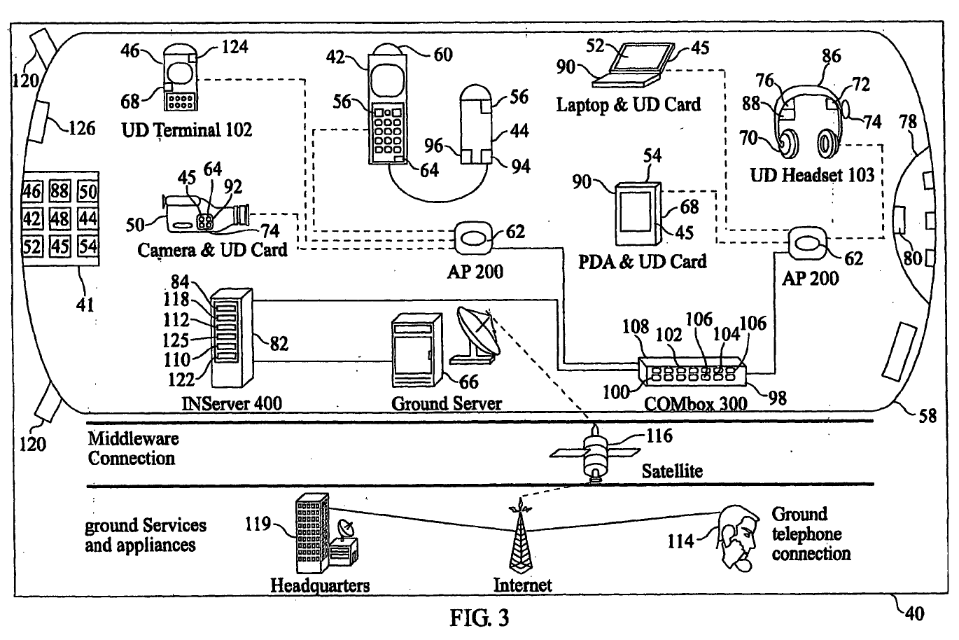

FIG. 3 shows a schematic view of the system of the present invention as part of an airplane system 40. As can be seen in FIG. 3, the hardware apparatus of the present invention can optionally work as a stand alone user device 41 (UD). Examples of UD technology devices 41 include, but are not limited to UD phone 42, UD adaptor 44, UD card 45, UD terminal 46 and UD headset 48, camera 50 and UD card 45, laptop 52 and UD card 45 and PDA 54 and UD card 45. Preferably, UD 41 features the INChip 56 inside. Alternatively, the hardware apparatus of the present invention is incorporated into any suitable mobile or stationary communication device

In one preferred embodiment of a UD phone 42 on an airplane 58, UD phone 42 includes features of a mobile phone and a special infrared transceiver 60, which readily facilitates immediate wireless connection to access points (APs) 62 without any wires from any location on airplane 58.

Preferably, UD 41, such as UD phone 42 includes a SIM card reader 64, which reads the SIM card identity. Preferably, the SIM contains the basic user information, such as, but not limited to, origin, billing, phone numbers, operator codes and the like. Preferably, UD 42 operates by connecting to the INetworking and delivers all the necessary identification details from the SIM card to allow billing services and identification services.

Optionally, if UD 42 is implemented inside a conventional mobile phone, the UD technology replaces the RF transmission with infrared transceiving. In an alternative preferred embodiment, the UD 42 is a stand alone UD device 42 and as such does not include RF capabilities inside an infrared environment. If plane 58 has on ground telephone connection 114 using a provider service 66, UD 42 is ready to connect and receive calls, data and SMS as usual. The system of the present invention 40 is a two-way system and as such, the user can use UD 42 to make outgoing calls, send SMS messages using WAP services and internet connection. UD 42 send IR signals in the airplane's hall 58 to infrared access points 62, whereby access points 62 are configured to simultaneously control several UD's 41, which facilitates roaming of UD's 41 and provides an infrared environment inside airplane 58.

In an alternative embodiment, the UD technology is implemented in a terminal 46, such as, but not limited to a small handheld, mobile or fixed terminal 46, which has infrared capabilities and connects to the INetworking. A UD terminal 46 for use of the airplane crew allows the crew in the cockpit 78 to be in constant communication with the airplane staff. The internal airplane communication systems of the art use a wired fixed intercom installed in the airplane galley 58. This type of system is limited in that it does not help in real time when the needed person is not in the galley. Preferably, UD 46 connects by infrared diffused beams to infrared access points 62, which are preferably mounted inside the aircraft 58. Optionally, the terminal UD 46 can be constructed in any suitable form, such as, but not limited to, a walkie-talkie, a bigger device with screen and live video display capabilities. Optionally, UD 46 can be connected using the INServer 82 to the airplane intercom system for communication and integration with existing onboard communication devices.

Optionally, UD terminal 46 is configured to provide selection of who to call and includes a personalized list of clients. Optionally, user can switch a button 68, whereby UD terminal 46 user can choose who to call and wherein a display presents the Caller ID, as optionally, there will be several UD terminals 46 in use during a flight.

Optionally, UD 41 of the present invention is incorporated in a headset device 48. A headset device 48 is configured to readily provide a means for passengers' entertainment, service and crew communication. Passengers' entertainment includes soundtracks of movies, radio, music and the like. UD headset 48 uses INServer 82 to connect to the sound source of the onboard entertainment systems or the music source. Optionally, UD headset 48 by connection to INServer 82 allows passengers to get a flight attendant's attention.

A UD headset device 48 for crew communication connects wirelessly access points 62, using two-way communication. Preferably, the crew headsets 48 feature a microphone 68, at least one earphone 70, power source 72 and INChip components 74. Preferably, headset 48 facilitates mobility of the crew. Optionally, UD headsets 48 for crew are equipped with a coder/encoder 76 to assure voice transmitting security. In addition, optionally, the coder/decoder 76 of UDs 48 function as a key to enter cabin 78 or to ask access to unlock the cabin's door 80. One mechanism, which is in no way limiting, is that the request from the crew UD 48 is sent to INServer 82, which connects to the door 80 lock/unlock mechanism. Preferably, there is a software authorization mode in INServer 82, which assures that only registered users which are specified in INServer directory 84 as crew members are permitted to use the system 40. This combination readily facilitates safe and secure voice and data transmitting for crew and airplane systems.

Optionally, UD headset 48 includes an ergonomic bow 86 to help device 48 sit comfortably on the user's head. Different versions of UD headset 48 of the present invention include a small UD 48 for aircrew, which features a microphone 68 and a speaker 88, which works as earpiece or earphone 70. Preferably, this system is a two-way device so that the crew member can talk and receive voice calls.

An alternative UD version 48 is a UD 48 for passenger's entertainment. Preferably, UD 48 for passenger's entertainment features at least one HI FI quality earpiece 70, speakers 88, power source 72 and INChip 74. Preferably, UD 48 for passenger's entertainment does not include microphone 68.

Optionally, the UD technology is incorporated in a UD card 45. Preferably, UD card 45 connects INetworking with laptops 52 or PDAs 54. Optionally, UD card 45 is a PCMCIA card 45 or USB card 45 or a card 45 with compatibility to PDA 54 or a laptop's 52 communication slot 90 or port. Preferably, UD card 45 has IR beaming capabilities and like the rest of the UD family 41 connects via infrared to access points 62.

In one preferred embodiment, UD card 45 features a SIM card reader 64, which facilitates checking personal details of a user for billing and personalized services. Optionally, a SIM can belong to a cellular operator (carrier) or to the airliner, which operates the airplane or to any other organization or business, which supplies parts of this connection or provide access service to the passengers.

In an alternative preferred embodiment, UD card 45 is a direct version, wherein UD card 45 connects directly to the INetworking, delivering the needed data without SIM. Optionally the structure can include a SIM card reader 64 and a software bypass, or alternatively the structure may not include an SIM card reader 64. Access is controlled by INSever 82. Preferably, UD card 45 includes a code 92, which is burned on INchip 74, in order that it is recognized by the INetworking/INServer 82 and obtains only data needed.

Preferably, UD card 45 facilitates a networking connection between access points 62 to laptops 52 or PDAs 54. Optionally, if there is an internet connection, UD card 45 can be used to provide internet and email access service.

Optionally, the UD technology is incorporated in a UD adaptor 44. Preferably, a UD adaptor 44 is an electronic box with infrared capability and ports to connect other devices. Preferably, UD adaptor 44 is a stand alone device and includes the features of UD card 45. However UD adaptor 44 is stand alone and connected to peripheral applications and devices, such as, but not limited to printers, video cameras with the appropriate sockets and cables. Preferably, UD adaptor 44 has an internal power source 96, but also can make use of the connected devices power.

Preferably, Access Points (AP) 62 used in the present invention is a fixed transceiver unit 62, which can optionally be mounted inside the airplane 58. AP 62 connects between UD 41 via infrared beams and to the Communication boxes 98, such as HUB, switch, router by fixed lines or cables, which connect to INServer 82. Preferably, several AP's 62 are installed inside airplane hall 58. Preferably, AP 62 creates two-way communication of voice, video and data to and from UDs 41.

Preferably, communication boxes (COMbox) 98 used in the present invention work like an automatic switchboard. COMbox 98 and includes HUB 100, Switch 102 and router 104. Preferably, one side of COMbox 98 features multiple ports 106 to connect to wires, which lead to APs 62 that are installed in the airplane 58 like a regular LAN. Preferably, a second side 108 of COMbox has ports, which connect with wires to INServer 82. Preferably, transmission of the information via wires to ,APs 62 delivers voice over IP, video, e-mail, internet, crew communication and the like. Preferably, the system is fully modular and can be built in several ways.

In one preferred embodiment, there are several COMboxes 98, wherein each COMbox 98 has a different function, such as one COMbox 98 is dedicated for passenger's voice, another COMbox 98 is for onboard video equipment and another COMbox 98 is for crew communication use. Optionally, all COMboxes 98 can work together in parallel with no interference between them. An alternative configuration is one COMbox 98 which is configured to readily facilitate all applications, such as data, crew voice, passengers voice, entertainment, video, transponders, alerting and the like.

INServer of the present invention 82 is a computer with large processing and storage facilities. In order to be able to work in a critic mission environment, preferably, INServer 82 includes full redundancy, backup system and easy access to facilitate changing components without turning off the power. The computer software 110 controls INetworking. Optionally, there are several versions of INServer 82, such as a package of hardware and software together or a modular software based application ready to install in a strong reliable computer. The final product is structured to fit the users needs.

Preferably, INServer 82 connects to COMboxes 98 via one of the ports for controlling and delivering data voice and media 112. Optionally, INServer 82 can simultaneously broadcast media from its own storage and function as a gateway to deliver information from other sources, such as, but not limited to onboard communication system with ground telephony 114.

Preferably, INServer 82 connects to the passengers UD phone 42 via APs 62 and applies telephony services. The final access to ground telephony system 114 is completed with a provider 66, which creates the connection between airplane 58 and ground telephony services 114. Optionally, the providers use satellite 116 to create this connection.

In one non-limiting example, wherein a plane 58 has it own internet service, INServer 82 delivers the media wirelessly, eliminating the need to pre-wire the seats with jacks or ports and supply adapters to fit numerous kinds of laptops 52 or PDAs 54, which passengers have brought onto plane 58.

Optionally, INServer 82 can provide a flight information backup system, cabin door control and black box reader. Optionally, INServer 82 features a GPS and flight recording and backup system, video captures, images, records of calls inside airplane 58, UD devices 41 connection history and the like. All this information is stored in INServer 82 and can be transmitted in real time or by demand. INServer 82 filters the data it need to send or store via INServer operating software 110.

Preferably, INServer 82 has a built in cellular engine/modem 118, which is connected using a cellular network to the user, when airplane 58 is on the ground. In flight, connection is done by using third party providers of ground connection 66, which use satellite 116 to deliver information. Preferably, this information is encrypted and protected to achieve maximum security and privacy.

Preferably, the system of the present invention 40 includes a keyboard and display using a simple operating system for maintaining INServer 82 during the flight. Optionally, INServer 82 can be accessed during flight from other sources, such as other airplanes and ground based services. In order to maintain high security, access to INServer 82 can only be done with the dedicated accessibility tools and strict authentication policy.

Preferably, INServer 82 has remote control capabilities using a regular wireless, cellular or satellite connection to allow easy maintenance. All the necessary work can be done from a remote computer or terminal, which is equipped with the dedicated authorization codes an accessibility features.

Preferably, INServer 82 can provide a means for crew training and surveillance. Data can be recalled from INServer 82 and analysed. Preferably, the information is stored locally in INServer 82 as a file and then is transmitted using appropriate accessing codes to remote computers.

Optionally, INServer 82 provides a means for remote supervising on the ground and in flight, such as of cleaning and maintenance work. A user can watch work being executed by using onboard cameras and voice system.

A further use of the system of the present invention 40 is video conferencing. During the flight, the aircraft crew can use video conferencing for contacting headquarters 119, for example to deliver a live video from a camera 50 that points on a certain engine 120 and thereby consult about engine 120 problems. Camera 50 must have a UD adaptor 44 to connect to the INetworking. In addition video conferencing can be provided for the passengers use, whereby INServer 82 connects information from wireless camera 50 to an IP address or a computer address on the ground using the airline internet or third party satellite connections 116.

Preferably, INServer 82 features an authentication module 122, which controls the crew communication system equipped with terminal 46 or with UD headsets 48. The remote UD has a coder/encoder feature 124 embedded inside. INServer 82 authenticates each one of the crew's identity by verification with coder/encoder 124, readily facilitating creating a security shield to apply the needed data to those persons only. Authentication module 122 can also be used to identify onboard sensors 126, which deliver flight details.

Preferably, INServer 82 identifies each one of the users with different permits according to pre-defined parameters. Preferably, INServer 82 records all the details from the users who use SIM cards. Preferably, all INServer 82 users will have to match the destination zones, which they are permitted to access in the INServer's 82 database. Preferably, access to restricted zones in INServer 82 require password and authentication codes.

Preferably, all INServer's 82 users have their own serial number. INServer 82 stores all the serial numbers it supports, including, but not limited to APs 62, UDs, wireless keys for cabin doors, and wireless panic buttons. Optionally, INServer 82 has an encryption module 125, which encrypts the serial numbers. Alternatively, a firewall can also be applied. Preferably, any attempt to access INServer 82 from another source outside airplane 58 needs verification and the encryption code of the serial numbers. Preferably, all information regarding serial numbers and the encryption code will be maintained secret.

It will be appreciated that the above descriptions are intended only to serve as examples, and that many other embodiments are possible within the spirit and the scope of the present invention.

1. A communication device using infrared comprising:
(a) an integrated infrared chip (INChip);
(b) a driver; and
(c) an infrared transceiver.

2. The communication device of claim 1, wherein said INChip supports infrared wireless networking.

3. The communication device of claim 1, wherein said device is for use on an aircraft.

4. The communication device of claim 1, wherein said infrared transceiver is an antenna, for readily negotiating between an end device connected to said infrared chip and a network section

5. The communication device of claim 1, wherein said device is selected from at least one of the group consisting of mobile phones, wireless telephone, mobile headsets, mobile two way headsets, dedicated Computer cards, a digital camera, PDA, laptops and a combination thereof.

6. The communication device of claim 1, wherein said INChip has infrared transmitting/receiving capabilities.

7. The communication device of claim 1, wherein said INChip transmits all the necessary information to the device it is attached to.

8. The communication device of claim 1, wherein said INChip is integrated inside said communication device.

9. The communication device of claim 1, wherein said INChip is located outside said communication device.

10. The communication device of claim 9, wherein said communication device is connected to an external device for infrared transceiving.

11. The communication device of claim 10, wherein said external device for infrared transceiving comprises an INChip and an infrared transceiver.

12. The communication device of claim 10, wherein said device is connected by a connection device to said external device for infrared transceiving.

13. The communication device of claim 1, wherein said INChip comprises modular based software.

14. The communication device of claim 13, wherein said software is configured to support a plurality of communication devices.

15. The communication device of claim 13, wherein said software is configured to have a plurality of variations for readily facilitating firmware changing.

16. The communication device of claim 1, wherein said INChip is configured to readily facilitate application with a variety of different devices, servers, applications and manufacturers.

17. The communication device of claim 1, wherein said device identifies voice and data infrared networking.

18. The communication device of claim 1, wherein said driver readily facilitates attaching said device to a wireless networking system (INetworking).

19. The communication device of claim 1, wherein one end of said driver connects to an end device and the other end of said driver connects to compatible protocol for INetworking.

20. The communication device of claim 1, wherein said device is configured to readily facilitate switching between RF to IR networking.

21-68. (canceled)
